(19) United States
(12) Patent Application Publication
(10) Pub. No.: US 2026/0369057 A1
(43) Pub. Date: Nov. 19, 2026

(54) SYSTEMS AND PROCESSES FOR INTELLIGENT IDENTIFICATION OF PHYSICAL OBJECTS

(71) Applicant: CesiumAstro Inc., Austin, TX (US)

(72) Inventors: Joseph Gregory Ellis, Austin, TX (US); Adam William Drescher, Knoxville, TN (US); Gianni Galbiati, Boulder, CO (US); Robert Zachary Taylor, Knoxville, TN (US); Clifton Charles Sluss, Oak Ridge, TN (US); Kalea Shea Gore, Watertown, MA (US)

(21) Appl. No.: 19/677,410

(22) Filed: May 14, 2026

Related U.S. Application Data
(60) Provisional application No. 63/805,386, filed on May 14, 2025.

(51) Int. Cl. G06V 20/40; G06V 10/764

(52) U.S. Cl. CPC G06V 20/41; G06V 10/764

(57) ABSTRACT

A computing device can receive media data comprising a sequence of frames captured by a sensor. A computing device can identify one or more object detections within the frames. A computing device can generate a plurality of candidate tracks across the sequence of frames, wherein each candidate track is associated with a subset of the object detections. A computing device can generate a plurality of object representations for each candidate track derived from the media data and the associated subset of object detections. A computing device can select a subset of the candidate tracks based on spatiotemporal consistency. A computing device can compare object representations associated with a first candidate track against object representations associated with a second candidate track. A computing device can assign an object identity to the subset of object detections associated with the first and second candidate tracks based on the comparison and the spatiotemporal consistency.

### CROSS-REFERENCE TO RELATED APPLICATIONS

This application is a non-provisional application, claiming the benefit of and priority to U.S. Provisional Application No. 63/805,386, filed on May 14, 2025, entitled “SYSTEMS AND PROCESSES FOR INTELLIGENT IDENTIFICATION OF PHYSICAL OBJECTS,” the entirety of which is incorporated by reference as if fully set forth herein.

### TECHNICAL FIELD

The present systems and processes relate generally to computer vision and machine learning, and more particularly to intelligent identification of physical objects via computer vision and machine learning.

### BACKGROUND

Computer systems used in the intelligence, surveillance, and reconnaissance (ISR) fields produce and analyze an enormous volume of sensor-derived data (e.g., video cameras, infrared sensors, radar systems, LiDAR devices, or other sensing technologies). For example, these systems use this sensor-derived data for object detection. While object detection techniques can identify objects within individual sensor observations, a continuing technical challenge lies in re-identifying physical objects across multiple observations captured over time, particularly when observations occur at different locations, under varying conditions, or from different sensors.

In many existing systems, re-identification fails when different physical objects produce similar representations (e.g., multiple people wear similar clothing, vehicles of similar type or color appear in proximity, different modes of transportation generate overlapping sensor signatures). Other systems apply object tracking to associate detections over time, but tracking is frequently optimized for a single object type and limited to short temporal windows, and is often decoupled from identity assignment logic. As a result, systems that work reasonably well for one class of objects, such as pedestrians, often perform poorly when applied to other object classes, such as vehicles, vessels, or mixed transportation environments, leading to identity switching, track fragmentation, or false associations. Therefore, there exists a long-felt but unresolved need for systems that re-identify physical objects across sensor observations by jointly accounting for object movement over time and sensor-derived representations in a unified computational framework.

### BRIEF SUMMARY

Briefly described, and according to one embodiment, aspects of the present disclosure generally relate to systems and processes for intelligent identification of physical objects.

The present disclosure describes systems and processes for detecting, identifying, and reidentifying physical objects that address the long-felt but unresolved technical challenges in conventional object reidentification systems. Existing systems fail to reidentify physical objects when different physical objects produce similar representations, and tracking systems are frequently limited to short temporal windows, optimized for a single object type, and decoupled from identity assignment logic. The systems and processes disclosed herein overcome these technical deficiencies by jointly accounting for object movement over time and sensor-derived representations in a unified computational framework, thereby improving object classification speed, accuracy, and precision over conventional systems.

The systems and processes can use various computer vision and machine learning techniques for detecting and identifying physical objects. The system can process data received from various data sources across various modalities (e.g., images, video, audio, infrared, LiDAR, etc.). The system can generate a plurality of candidate tracks across a sequence of frames captured by at least one sensor, wherein each candidate track is associated with a subset of object detections. The system can generate, for each candidate track, a plurality of object representations derived from the multi-modal signal data and the associated subset of object detections. The system can select a subset of candidate tracks based on spatiotemporal consistency between the candidate tracks, and compare object representations associated with different candidate tracks to assign an object identity to the associated subset of object detections. By combining visual similarity with spatiotemporal consistency, the disclosed systems and processes reduce false positive identifications that arise in conventional systems relying on appearance alone, and further enable reidentification of physical objects across different sensors, vantage points, and points in time at an otherwise impossible scale and speed.

The systems and processes discussed herein include a media processing pipeline or a multi-modal signal processing pipeline (MPP) which can include a directed acyclic graph (DAG) including a plurality of machine learning algorithms and models that can be triggered, ad hoc, for generating processing jobs based on information identified within an initial media input or multi-modal signal input. Implementing a directed acyclic graph allows for inferences from one branch of the graph to be provided as inputs to machine learning models on other graph branches, allowing the system to dynamically scale machine learning inference jobs based on the received content and its properties.

In response to detecting and identifying a physical object, the system is configured to store a representation of the physical object, and metadata associated with the system's detection of the physical object, in one or more databases. The database and data structure discussed herein allow for the system to categorize and denote aspects of metadata within a video, image, or any other digital content, and to represent relationships between metadata corresponding to various database objects. In response to identifying an object in a stream of digital content, the system can efficiently reference other objects stored within the database for determining when, and where, the same object was previously identified.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a diagram illustrating an example identification process, in accordance with the disclosed technology;

FIG. 2 is a diagram illustrating an example system architecture, in accordance with the disclosed technology;

FIG. 3 is a flowchart of an example image identification process, in accordance with the disclosed technology;

FIG. 4 is a flowchart of an example video identification process, in accordance with the disclosed technology;

FIG. 5 is a flowchart of an example media processing pipeline, in accordance with the disclosed technology;

FIG. 6 is an example data structure, in accordance with the disclosed technology;

FIG. 7 is a screenshot of an example metadata inspection interface, in accordance with the disclosed technology; and

FIG. 8 is a computing device, in accordance with the disclosed technology.

### DETAILED DESCRIPTION

Some examples of the disclosed technology will be described more fully with reference to the accompanying drawings. However, this disclosed technology may be embodied in many different forms and should not be construed as limited to the implementations set forth herein. The components described hereinafter as making up various elements of the disclosed technology are intended to be illustrative and not restrictive. Indeed, it is to be understood that other examples are contemplated. Many suitable components that would perform the same or similar functions as components described herein are intended to be embraced within the scope of the disclosed electronic devices and methods. Such other components not described herein may include, but are not limited to, for example, components developed after development of the disclosed technology.

Throughout this disclosure, various aspects of the disclosed technology can be presented in a range of formats (e.g., a range of values). It should be understood that such descriptions are merely for convenience and brevity and should not be construed as an inflexible limitation on the scope of the disclosed technology. Accordingly, the description of a range should be considered to have specifically disclosed all the possible subranges as well as individual rational numerical values within that range. For example, a range described as being “from 1 to 6” or “from approximately 1 to approximately 6” includes the values 1, 6, and all values therebetween. Likewise, a range described as being “between 1 and 6” or “between approximately 1 and approximately 6” includes the values 1, 6, and all values therebetween. The same premise applies to any other language describing a range of values. That is to say, the ranges disclosed herein are inclusive of the respective endpoints, unless otherwise indicated.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicates that different instances of like objects are being referred to and are not intended to imply that the objects so described should be in a given sequence, either temporally, spatially, in ranking, or in any other manner.

Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the illustrative examples provided in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

As used herein, unless otherwise specified, the terms and/or phrases, “real-time,” “substantially real-time,” “instantaneously,” and “substantially instantaneously” each refer to processing and/or displaying data without intentional delay, given the processing limitations of the system (e.g., the limitations of one or more processors and/or memory of the system).

According to a first aspect, or any other aspect described herein, the present disclosure describes a system including: a memory storing executable instructions; and a processor in communication with the memory configured to execute the instructions to: receive media data comprising a sequence of frames captured by at least one sensor; identify one or more object detections within the sequence of frames; generate a track for each of the one or more object detections; generate at least one vector representation for each of the one or more object detections, wherein the at least one vector representation represents a physical or behavioral characteristic of a respective object detection; retrieve a plurality of prior tracks and a plurality of prior vector representations from the memory, wherein the plurality of prior tracks and the plurality of prior vector representations are associated with a plurality of prior object detections; compare a particular track associated with a particular object detection of the one or more object detections to each of the plurality of prior tracks to determine a trajectory score with respect to each of the plurality of prior tracks; compare at least one particular vector representation associated with the particular object detection to each of the plurality of prior vector representations to determine a similarity score with respect to each of the plurality of prior vector representations; and upon a determination that a particular trajectory score corresponding to a particular prior track and a particular similarity score corresponding to a particular prior vector representation exceed at least one predefined threshold, determine that the particular object detection identifies a same object associated with the particular prior track and the particular prior vector representation.

According to a second aspect, or any other aspect herein, the system of the first aspect, further configured to: assign an object identity to the particular object detection and a particular prior object detection corresponding to the particular prior track and the particular prior vector representation.

According to a third aspect, or any other aspect herein, the system of the second aspect, wherein the object identity corresponds to the same object.

According to a fourth aspect, or any other aspect herein, the system of the first aspect, wherein the particular track and the particular prior track represent a movement path of the same object over a period of time.

According to a fifth aspect, or any other aspect herein, wherein the plurality of prior tracks and the plurality of prior vector representations are generated from the media data from the sequence of frames.

According to a sixth aspect, or any other aspect herein, the system of the first aspect, wherein plurality of prior tracks and the plurality of prior vector representations are generated from prior media data from a prior sequence of frames.

According to a seventh aspect, or any other aspect herein, a method including: receiving, via one of one or more computing devices, media data comprising a sequence of frames captured by at least one sensor; identifying, via one of the one or more computing devices, one or more object detections within the sequence of frames; generating, via one of the one or more computing devices, a track for each of the one or more object detections; generating, via one of the one or more computing devices, at least one vector representation for each of the one or more object detections, wherein the at least one vector representation represents a physical or behavioral characteristic of a respective object detection; retrieving, via one of the one or more computing devices, a plurality of prior tracks and a plurality of prior vector representations from a data store, wherein the plurality of prior tracks and the plurality of prior vector representations are associated with a plurality of prior object detections; comparing, via one of the one or more computing devices, a particular track associated with a particular object detection of the one or more object detections to each of the plurality of prior tracks to determine a trajectory score with respect to each of the plurality of prior tracks; comparing, via one of the one or more computing devices, at least one particular vector representation associated with the particular object detection to each of the plurality of prior vector representations to determine a similarity score with respect to each of the plurality of prior vector representations; and upon a determination that a particular trajectory score corresponding to a particular prior track and a particular similarity score corresponding to a particular prior vector representation exceed at least one predefined threshold, determining, via one of the one or more computing devices, that the particular object detection identifies a same object associated with the particular prior track and the particular prior vector representation.

According to an eighth aspect, or any other aspect herein, the method of the seventh aspect, further including: combining the particular trajectory score and the particular similarity score to generate a combined score; and determining that the combined score exceeds the at least one predefined threshold.

According to a ninth aspect, or any other aspect herein, the method of the seventh aspect, wherein determining that the particular trajectory score corresponding to the particular prior track and the particular similarity score corresponding to the particular prior vector representation exceed the at least one predefined threshold comprises: determining that the particular trajectory score exceeds a trajectory threshold; and determining that the particular similarity score exceeds a similarity threshold, wherein the at least one predefined threshold comprises the trajectory threshold and the similarity threshold.

According to a tenth aspect, or any other aspect herein, the method of the seventh aspect, wherein each of the one or more object detections comprises a person, vehicle, or vessel.

According to an eleventh aspect, or any other aspect herein, the method of the seventh aspect, wherein identifying the one or more object detections comprises performing object detection on each frame in the sequence of frames.

According to a twelfth aspect, or any other aspect herein, the method of the seventh aspect, wherein generating the track for each of the one or more object detections comprises associating the one or more object detections in adjacent frames of the sequence of frames.

According to a thirteenth aspect, or any other aspect herein, a non-transitory computer-readable medium embodying a program that, when executed by at least one computing device, cause the at least one computing device to: receive sensor data captured by at least one sensor over a period of time; identify one or more object detections within the sensor data; generate a track for each of the one or more object detections; generate at least one vector representation for each of the one or more object detections, wherein the at least one vector representation represents a physical or behavioral characteristic of a respective object detection; retrieve a plurality of prior tracks and a plurality of prior vector representations from a data store, wherein the plurality of prior tracks and the plurality of prior vector representations are associated with a plurality of prior object detections; compare a particular track associated with a particular object detection of the one or more object detections to each of the plurality of prior tracks to determine a trajectory score with respect to each of the plurality of prior tracks; compare at least one particular vector representation associated with the particular object detection to each of the plurality of prior vector representations to determine a similarity score with respect to each of the plurality of prior vector representations; and upon a determination that a particular trajectory score corresponding to a particular prior track and a particular similarity score corresponding to a particular prior vector representation exceed at least one predefined threshold, determine that the particular object detection identifies a same object associated with the particular prior track and the particular prior vector representation.

According to a fourteenth aspect, or any other aspect herein, non-transitory computer-readable medium of the thirteenth aspect, wherein the at least one sensor comprises at least one of: a photographic camera, a video camera, a radar sensor, a LiDAR sensor, a microphone, an infrared sensor, or a synthetic aperture radar sensor.

According to a fifteenth aspect, or any other aspect herein, non-transitory computer-readable medium of the thirteenth aspect, the at least one particular vector representation and the particular prior vector representation correspond to a single characteristic of the same object.

According to a sixteenth aspect, or any other aspect herein, non-transitory computer-readable medium of the thirteenth aspect, wherein the particular trajectory score measures a spatiotemporal consistency between the particular prior track and the particular track.

According to a seventeenth aspect, or any other aspect herein, non-transitory computer-readable medium of the thirteenth aspect, wherein comparing the at least one particular vector representation with the particular prior vector representation comprises calculating a distance metric between the at least one particular vector representation and the particular prior vector representation.

According to an eighteenth aspect, or any other aspect herein, non-transitory computer-readable medium of the thirteenth aspect, further configured to cause the at least one computing device to: generate each of the plurality of prior tracks for each of the plurality of prior object detections based on the sensor data.

According to a nineteenth aspect, or any other aspect herein, non-transitory computer-readable medium of the thirteenth aspect, further configured to cause the at least one computing device to: generate each of plurality of prior vector representations for each of the plurality of prior object detections based on the sensor data.

According to a twentieth aspect, or any other aspect herein, non-transitory computer-readable medium of the thirteenth aspect, further configured to cause the at least one computing device to: store, in the data store, the plurality of prior tracks and the plurality of prior vector representation.

Although the disclosed technology may be described herein with respect to various systems, non-transitory computer-readable mediums having instructions stored thereon, and methods, it is contemplated that embodiments or implementations of the disclosed technology with identical or substantially similar features may alternatively be implemented as methods, systems, and/or non-transitory computer-readable media. For example, any aspects, elements, features, or the like described herein with respect to a method can be equally attributable to a system and/or a non-transitory computer-readable medium. As another example, any aspects, elements, features, or the like described herein with respect to a system can be equally attributable to a method and/or a non-transitory computer-readable medium. As yet another example, any aspects, elements, features, or the like described herein with respect to a non-transitory computer-readable medium can be equally attributable to a system and/or a method.

### Overview

Briefly described, and according to one embodiment, aspects of the present disclosure generally relate to systems and processes for intelligent identification of physical objects.

In at least one example, the present disclosure describes systems and processes for detecting, identifying, and reidentifying physical objects. The systems and processes discussed herein can leverage various computer vision and machine learning techniques for detecting and identifying the physical objects. As will be discussed throughout the present disclosure, the system can process data received from various data sources across various modalities (e.g., images, video, audio, etc.). Moreover, the system can be configured to generate inferences (via one or more machine learning models) from a particular data source of a particular modality. The system can furthermore provide the generated inferences as inputs to a separate machine learning model which can be configured to process separate (but related) data of a separate modality. In one example, the system and processes discussed herein include a media processing pipeline or a multi-modal signal processing pipeline (MPP) which can include a directed graph (such as a directed acyclic graph) including a plurality of machine learning algorithms and models that can be triggered, ad hoc, for generating processing jobs based on information identified within an initial media input or multi-modal signal input. In embodiments where the MPP includes a directed acyclic graph (DAG), the graph structure can include multiple ancestor nodes. Implementing a directed acyclic graph allows for inferences from one “branch” of the graph to be provided as inputs to machine learning models on other graph branches.

As will be discussed in greater detail herein, the system is configured to leverage various machine learning and artificial intelligence techniques for processing images, video, audio, etc., and for identifying objects within the same. The system can be configured to dynamically scale, up or down, machine learning inference jobs. In various embodiments, the system can be configured to determine one or more types of machine learning jobs (and a number of jobs) to run based on the images, video, audio, etc., to be processed. Accordingly, given any input (e.g., video, audio, images, etc.), the system can be configured to run one or more machine learning jobs that are orchestrated based on the received content to be processed and the content properties. It should be understood from the discussion herein that a machine learning job may include one or more tasks or workflows executed to train, evaluate, and/or deploy one or more machine learning models. In various embodiments, machine learning jobs can be discrete units of computer processing in a machine learning execution pipeline. Machine learning jobs can include one or more of data preparation (data collection, data cleaning, data preprocessing, etc.), model training and/or retraining, execution, etc. In various embodiments, the number of machine learning jobs run by the system can be based on video length, which machine learning models an end user is “subscribed to,” outputs from other machine learning models created previously in a processing chain within the directed acyclic graph, etc. For example, a number of audio transcription jobs can depend upon a number of voice activity segments detected by a voice activity detection model. In various embodiments, this type of relationship can exist throughout the processing pipeline and graph.

In response to detecting and identifying a physical object, the system is configured to store a representation of the physical object, and metadata associated with the system's detection of the physical object, in one or more databases. According to various aspects of the present disclosure, the database and data structure(s) discussed herein allow for the system to categorize and denote pieces, or aspects, of metadata within a video, image, or any other digital content. In one embodiment, the database and data structure(s) can be configured to represent relationships between metadata corresponding to various database objects. For example, the database and data structure(s) can be configured such that two separate videos in which similar metadata is identified (e.g., a common ship, person, object, etc.) can include a shared relationship corresponding to the metadata. In one example, a data object stored within the database discussed herein can include a pointer to other data objects within the database that include commonly identified objects. In this way, and in response to identifying an object in a stream of digital content, the system can efficiently reference other objects stored within the database for determining when, and where, the same object was previously identified.

The system can include a metadata inspection interface (also referred to herein simply as “the interface”). In one example, the interface can be a graphical user interface (GUI). In various embodiments, the interface can allow for the system to display (for example, on a screen operatively connected to a computing device), relationships between metadata identified across one or more different content streams and/or modalities. In a particular example, the interface can be a webpage. In various embodiments, the interface can include a dropdown menu for organizing metadata according to a metadata type (e.g., truck, ship, carrier, etc.). The interface can be configured to display a timeline of instances of detected metadata across a plurality of different content sources. In at least one example, the interface can display a particular content source, such as a video, adjacent to a list of metadata detected within the video. The interface can display a confidence score corresponding to each instance of detected metadata. In at least one example, the confidence score can be a statistical determination corresponding to similarities between vectors including metadata from different data sources.

### Example Embodiments

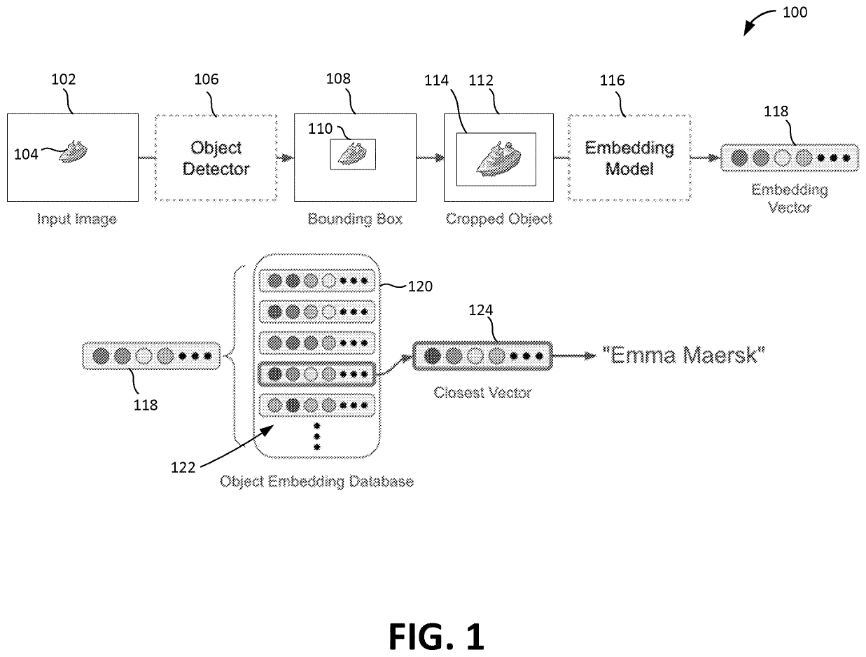

Referring now to the figures, for the purposes of example and explanation of the fundamental processes and components of the disclosed systems and methods, reference is made to FIG. 1, which is a diagram illustrating an example identification process 100, in accordance with the disclosed technology.

As will be understood from the discussion herein, the disclosed system can be configured to identify, and reidentify at a later time, one or more objects or targets of interest in an image, video, audio, or any sensor data type (e.g., infrared, radar, LiDAR). For example, the sensor data can include sensor data capture in a single point in time or over a period of time. In various embodiments, the process of identifying and reidentifying targets of interest can be referred to simply as reidentification (“ReID”). For example, reidentification can include detecting an object (e.g., a person, a vehicle, any type of object) at multiple points in time in a stream of sensor data over time (e.g., a video). For example, the video cameras can include stationary cameras, cameras that can pivot in a stationary location, and moveable cameras (e.g., on a drone or plane). Reidentification can include tracking objects as the objects move position in space over time in the stream of sensor data. As a non-limiting, illustrative example, a video camera can film vehicles (e.g., cars, trucks) in a parking lot. In this example, a white Toyota Camry® can enter into the video camera's field of vision. The ReID process can detect the car entering into the field of vision and track the car moving around the parking lot (e.g., within one or more camera's field of vision). For example, the ReID process can determine if a white Toyota Camry® in a particular frame of the video is the same white Toyota Camry® in a different frame of the video and distinguish between other white Toyota Camrys®. As another example, the ReID process can determine if a white Toyota Camry® identified in a camera feed from particular camera in a particular location is the same white Toyota Camry® identified in a different camera feed from a different camera in a different location. As another non-limiting, illustrative example, the ReID process can detect a person exiting a vehicle in the parking lot and as they walk around. For example, the system can determine if the person walks into or out of a building or enters into a different vehicle (e.g., not the vehicle that they exited). In one example, automating object detection and ReID improves surveillance systems by enhancing object classification speed, accuracy, precision, etc. Moreover, ReID allows for human analysts and system operators to aggregate information across various sources at an otherwise impossible scale and speed to produce coherent, up-to-date operating pictures.

In at least one example, the disclosed system can be configured to identify, and reidentify, objects such as ships or other vessels on the open water, at a marina, freight dock, or generally in any environment in which such objects could be located. In this scenario, the system can be operatively configured to identify physical characteristics corresponding to a ship (e.g., lettering, color patterns, flags, damage, equipment, etc.) and/or behavioral characteristics (e.g., speed, wake patterns, etc.). In various embodiments, and based on statistical similarities corresponding to those physical and/or behavioral characteristics, the system can determine if the ship or any other type of objects has been previously identified by the system. In this way, a ship or other object that was previously identified by the system (for example, in an image or video stream), can be reidentified in a separate image, video, etc. Similarly, the disclosed system can be configured to identify, and reidentify, people. For example, the system can be operatively configured to identify physical characteristics (e.g., height, skin color, hair color, worn accessories, clothing, gait, voice, etc.) and/or behavioral characteristics (e.g., travel habits, patterns in visited location frequency, walking/running pace, patterns with respect to travel companions, frequently operated vehicles, etc.). According to various aspects of the present disclosure, the system can be used for security purposes, law enforcement purposes, etc.

In one example, the reidentification process 100 can begin at step 102. In one example, step 102 includes receiving an input image. In various embodiments, the input image received at step 102 can be a ship 104. However, it should be understood from the discussion herein that the input image received at step 102 can be any object. For example, the object can be a vehicle, a human, an animal, stationary, moving, etc. In one example, the system can receive the input image via one or more sensors and/or data collection devices. For example, the one or more sensors can include cameras, video recorders, radar sensors, LiDAR sensors, microphones, infrared sensors, alternative image spectra sensors such as synthetic aperture radar (SAR) sensors, and generally any type of surveillance equipment capable of detecting physical objects (or the presence of physical objects). For example, the image can include a frame captured by a video camera.

In one example, the input image received at step 102 can be passed or transmitted to an object detector at step 106. In various embodiments, the object detector can be configured to perform image processing on the input image received at step 102. In one example, image processing via the object detector at step 106 can include one or more digital signal processing techniques such as optical character recognition (OCR), edge detection (via Canny edge detectors, Prewitt and/or Harris edge/corner detection operators, etc.), filters (e.g., Fourier transforms, convolution with kernels, etc.), image segmentation (via comparing pixel intensities to predetermined thresholds), feature detection, etc. In various embodiments, the object detector at step 106 can be configured to perform one or more machine learning algorithms or techniques to process the input image 102 for detecting an object within the image. In one example, the system can implement models such as a you-only-look-once model (e.g., “YOLO” v5, the Roboflow platform) or any other object detection model for object detection.

In one example, at step 108, the system can generate a bounding box 110 around the object detected by the system at the object detector at step 106. As shown in the present embodiment, the bounding box 110 includes a rectangular boundary around the ship 104. In one or more examples, the system can leverage computer vision algorithms and related techniques for modifying the input image to include the bounding box 110.

In one or more examples, at step 112, the system can crop the input image 104 to extract a cropped object 114. In various embodiments, the cropped object 114 can include an enlarged and/or enhanced image corresponding to the ship 104 of the input image 102. The system can be configured to pass the cropped object 114 to an embedding model 116. In one example, the embedding model can generate a vector, or an embedding vector 118, corresponding to the cropped object 114. In one example, the embedding model 116 can be configured to process the cropped object 114 to identify a plurality of statistical relationships between characteristics, attributes, features, etc., within the cropped object 114 and its corresponding data. In various embodiments, the system can implement an OSNet/ResNet50 convolutional neural network (CNN) architecture (or other architectures of the like) for generating the embedding model 116.

For example, the embedding, including the vector, can represent any physical characteristics and/or behavioral characteristics of the detected object. If the detected object is a person, physical characteristics can include height, weight skin color, hair color, worn accessories, clothing, gait, voice, scars, tattoos, and any other physical characteristics, and the behavioral characteristics can include travel habits, patterns in visited location frequency, walking/running pace, patterns with respect to travel companions, frequently operated vehicles, and any other behavioral characteristics. If the detected object is a vehicle such as a car or truck, the physical characteristics can include make, model, color, year, damage, text (e.g., license plate, signage, advertising, sticker), and the behavioral characteristics can include typical routes and travel patterns, typical speeds, traffic law violations, and any other behavioral characteristics. If the detected object is a ship, the physical characteristics can include type, lettering, color patterns, flags, damage, equipment, and shipping containers on board, and the behavioral characteristics can include speed, wake patterns, and typical travel routes. For example, a single embedding can represent a single particular characteristic or multiple characteristics.

The system can be configured to use one or more machine learning models to generate an embedding corresponding to the cropped object 114. In a particular example, the system can include a machine learning model that is specifically trained to identify statistical relationships between certain object types such as ships, cars, people, etc. For example. The system can include a plurality of machine learning models that are fine-tuned based on various domains in media and or multi-modal signal input. In various embodiments, the system can train one or more machine learning models with datasets including a synthesized or augmented set of images. The synthesized set of images can include a plurality of images to which the system applies a plurality of predetermined distortions (e.g., blurring, rotations, degradation, etc.). Generating a synthesized set of images allows for the system to create, for example, 100 images, by applying 10 unique transformations to each of 10 unique images.

In one example, the embedding vector 118 can include a unique set of statistical numbers, metrics, values, etc., that correspond to unique aspects of the cropped object 114. In various embodiments, the system can compare the embedding vector 118 to a plurality of embedding vectors 122 stored within an embedding database 120. In a particular example, comparing the embedding vector 118 to a plurality of embedding vectors 122 can include calculating distances between the embedding vectors. As will be understood by one of ordinary skill in the art, two embedding vectors that are closely positioned near one another in a vector embedding space (or embedding domain), generally represent objects that are statistically similar. Accordingly, the system can compare the embedding vector 118 to the plurality of embedding vectors 122 in a high-dimensional embedding domain to determine if one or more of the embedding vectors 122 match with, or correspond to, the embedding vector 118. In response to comparing the embedding vector 118 to the plurality of embedding vectors 122, the system can determine a closest vector 124, or a matched embedding vector. The closest vector 124 can correspond to one or more prior identifications of the ship 104. As shown in the present embodiment, the system can determine that the embedding vector 118 and the closest vector 124 both correspond to a ship named the “Emma Maersk.” For example, the ship named the “Emma Maersk,” could have been previously detected and identified in the same sensor feed (e.g., earlier in a video from a single camera), by a different sensor (e.g., video camera v. radar), or at a different point in time (e.g., the ship was previously identified days, weeks, or months ago).

In one embodiment, the reidentification process 100 as shown in FIG. 1 generally illustrates a process by which the system receives an input image and, via an object detector, identifies one or more objects of a particular class of interest within the image for reidentification. The system can be configured to reidentify objects in different scenes and environments within videos or content received from varying vantage points and/or modalities. In one example, the class of interest can be sea vessels, and the object can be the ship 104 as identified. In another example, a class of interest can be motor vehicles, and particular detected objects can be trucks, cars, etc. In one or more examples, the received image can be cropped, or otherwise modified, to including a bounding box (or any appropriate shape, such as circles, ovals, triangles, etc.) corresponding to, and positioned around, the detected object. The system can pass, or route, the cropped image to an embedding model. The embedding model can be configured to capture the distinct visual characteristics of the detected object and other identity characteristics. The embedding model can be configured to perform feature extraction on images via a convolutional neural network (CNN). In one or more embodiments, the embedding model can be specifically trained for object classification (for example, by training the model with diverse and/or tailored image databases). In particular embodiments, the embedding model can be specifically trained for contrastive loss, which can include minimizing a distance between similar embeddings and increasing a distance between dissimilar embeddings.

In one or more examples, the embedding model generates an embedding vector 118 corresponding to the cropped object 114. The system can compare the embedding vector 118 against a database of embedding vectors which correspond to previously identified objects. The system can compare the embedding vector 118 against a database of embedding vectors to search for, and determine, whether a sufficiently similar embedding vector is stored within the database. In one example, if the system determines that a sufficiently similar embedding vector is stored within the database, the embedding vector 118 and its sufficiently similar embedding vector are labeled (or otherwise indicated) as matching embedding vectors. In one example, the system can assign a common identity to the object detected within the input image and the object corresponding to the sufficiently similar embedding vector. In at least one example, the system can determine that embedding vectors are sufficiently similar if a distance metric (e.g., dot product, cosine similarity, Euclidean distance, etc.) meets or exceeds a predetermined threshold confidence score (e.g., 0.7, 0.75, 0.8, 0.85, etc.). However, it should be understood from the discussion herein that the threshold confidence score can be determined (or tuned) based on various system configurations and available data. A system database, or data structure, can include separate instances/items corresponding to the separate appearances of the object; however, the database can link the objects (for example, via pointers) within the database. In one example, both instances/items can point to a common or shared embedding vector.

In one embodiment, the input image 102 can include a multi-modal signal, for example from any type of sensor (e.g., LiDAR, infrared, radar, radio frequency) rather than a still image or video from a camera. At step 106, object detection can be performed on the multi-modal signal to detect any object, including the ship 104. For example, the multi-modal signal can include IQ data that can be used to generate an embedding and/or vector 118 at step 116. In other embodiments, the multi-modal signal can include IQ data that can be used in place of an embedding and/or vector 118 at step 116. For example, IQ data can include sensor data that includes information related to a phase signal from the sensor. For example, a radio frequency or radar sensor can generate IQ data. The embedding 118 can be compared to any other embedding 122 stored in the database 120. Based on the comparison, the closest vector 124 can be identified from the stored embeddings 122. In some embodiments, sensor data can be used in conjunction with camera data or without camera data to identify and re-identify objects.

In some embodiments, multiple different sensors, including different sensor modalities (e.g., camera, LiDAR, infrared, radar, audio, radio frequency, any sensor type), can be used for identification and re-identification. For example, the described systems can include an array of sensors with various different modalities. For example, an embedding generated by a first modality type can be compared to an embedding generated by any sensor of the same first modality type. As an illustrative example, an infrared sensor can be used to generate a heat signature or heat embedding, which can be compared to any signature, embedding, and/or vector generated by an infrared sensor. For example, an embedding can be generated from sensor data in addition to generating embeddings and a track using camera data. As another example, any sensor modalities (e.g., camera, LiDAR, infrared, radar, audio, radio frequency, any sensor type) can be used to generate a track. In these embodiments, the sensor data embeddings and tracks can provide a point of comparison to improve system performance and more accurately identify and re-identify objects. For example, the embeddings/vectors/signatures generated by non-camera sensors can be compared as described herein with reference to a camera sensor. As another example, the tracks generated by non-camera sensors can be compared as described herein with reference to a camera sensor.

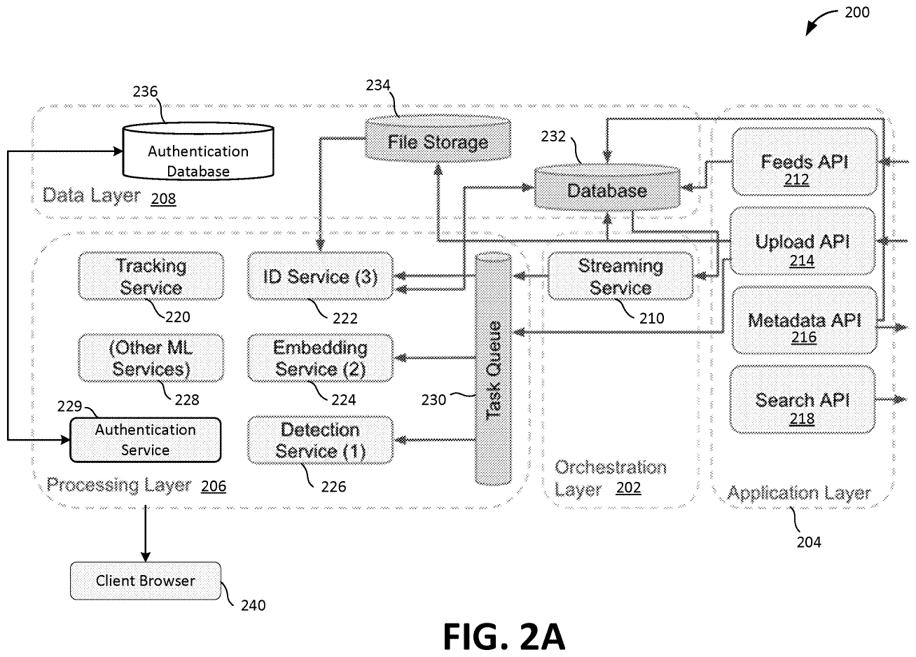

FIG. 2 is a diagram illustrating an example system architecture 200, in accordance with the disclosed technology. In one embodiment, the system architecture 200 can include a plurality of computing layers. According to various aspects of the present disclosure, the plurality of computing layers can include components such as virtual machines, containers, serverless functions (allowing for event-driven execution and automatic scaling), compute instances (graphics processing units (GPUs), tensor processing units (TPUs), etc.), etc. In various embodiments, the example system architecture 200 can be reside on one or more servers in a cloud-computing environment, such as in a containerized microservices system in a Kubernetes cluster. In particular embodiments, the example system architecture 200 can reside on one or more on-premises servers. In one or more examples, the system architecture 200 can include an orchestration layer 202, and application layer 204, a processing layer 206, and a data layer 208. The orchestration layer 202 can include a streaming service 210. In one example, the streaming service 210 can be operatively connected to interface with one or more APIs within the application layer 204. In one example, the streaming service 210 can be operatively connected to interface with one or more databases within the data layer 208. The streaming service 210 can be configured to receive digital content (such as multimedia streams, media uploads, multi-modal signals, etc.) in real-time from APIs within the application layer 204. As will be understood, any reference to media or multimedia can include multi-modal signals (e.g., data from a camera and/or any type of sensor). In one example, the streaming service 210 can be configured to receive, or retrieve, digital content or multi-modal signals from databases within the data layer 208 on an as-needed and/or as-available basis. As will be understood, the system architecture 200 can be in communication with a network, for example, the Internet, intranets, extranets, wide area networks (WANs), local area networks (LANs), wired networks, wireless networks, or other suitable networks, etc., or any combination of two or more such networks. Additionally, the system architecture 200 can be in communication with one or more computing devices configured to access the servers on which the system architecture 200 resides. For example, the computing devices and the servers can each include one or more processors and one or more data stores and can be configured to perform any of the functionality described herein.

In one example, the one or more APIs within the application layer 204 can include a feeds API 212 (for handling incoming media, multimedia, and multi-modal signal data feeds), an upload API 214 (for handling media data and multi-modal signal uploads to the system), a metadata API 216 (for handling metadata extracted from the processed media/multimedia/multi-modal signals), and a search API 218 (for handling database searching). It should be understood from the discussion herein that additional APIs can be included in the application layer 204, and that the system is not limited to the APIs as shown and discussed, and the present disclosure is not intended to limit the application layer 204 to the APIs as shown and discussed.

Processing tasks can be initiated directly by an API in the application layer 204, as well as ingestion services in the orchestration layer 202. In one embodiment, the orchestration layer 202 primarily coordinates processing jobs over video streams. In one embodiment, the application layer 204 provides an interface by which an external party can communicate with the processing backend. In one example, the feeds API 212 allows for a user to register new streams to monitor. In one embodiment, the upload API 214 allows new media to be directly submitted for processing. In various embodiments, object identities can be retrieved from the metadata API 216 at several granularities. In various embodiments, the search API 218 can be used for complex multi-modal queries.

The processing layer 206 can include a tracking service 220 (for tracking objects within multimedia streams), identification (ID) service 222 (for handling object identification, reidentification, and identity reconciliation), embedding service 224 (for generating and/or comparing embedding vectors), detection service 226 (for performing object detection within multimedia streams), one or more machine learning services 228, and an authentication service 229. In various embodiments, the one or more machine learning services 228 can include machine learning models that are trained for performing various processing steps associated with the detection service 226, the embedding service 224, the ID service 222, and the tracking service 220. In one example, the tracking service 220, ID service 222, embedding service 224, detection service 226, one or more machine learning services 228, and authentication service 229 can be dedicated processing modules running on one or more processors in a server. In one or more examples, the processing layer 206 can include a task queue 230. In various embodiments, the task queue 230 can receive data from the application layer, from the streaming service 210, and from other layers or data input sources, for orchestrating the system's task processing. The task queue can be included (or located) in other layers of the architecture 200, such as within the orchestration layer 202 (for improving system scalability). In one example, the task queue 230 can be configured to delegate processing jobs based on a volume (amount) and complexity of received multimedia. The task queue 230 can be configured to prioritize processing jobs based on available computing resources. The task queue 230 can be configured to operate as a “first in, first out” (FIFO) queue. The task queue 230 can be configured to operate according to a predetermined rules policy. In various embodiments, the task queue 230 can be configured to allow for asynchronous processing (holding certain jobs while one or more layers perform separate, but related, processing tasks). In particular embodiments, the task queue 230 can distribute a computing task, such as detecting and tracking an image within a video, across a plurality of containers running object detection models (such as the Yolo v5 model, or another similar model or model version). Any of the outputs from the processing layer 206, the orchestration layer 202, the application layer 204, and/or the data layer 208, including but not limited to object detection, reidentification, and tracking can be viewed on a user interface on a client browser 240. For example, the client browser 204 can include a web-based page accessible by any internet browser or an application stored on a computing device.

In one embodiment, the task queue can be implemented with a Redis in-memory database for coordinating successive processing stages. In various embodiments, the task queue can integrate with the services within the processing layer 206 for retrieving image content and configurations from the database, apply respective business logic, write results to the database, and mark the respective task for the next worker as “ready.” In particular embodiments, this arrangement can avoid direct message passing between microservices, which greatly simplifies system state management and networking, as well as routing every processing task through the same shared source of truth.

The data layer 208 can include one or more databases. For example, the data layer 208 can include a database 232 and an authentication database 236. The database 232 can store media, multimedia, or other content as received from the one or more APIs within the application layer 204. The database 232 can be a relational database. The database 232 can store metadata identified within images, videos, audio, and other digital content. The data layer 208 can also include a file storage database 234. The file storage database 234 can store object identifications (IDs), embeddings, and generally any data corresponding to identified and tracked objects. The file storage database 234 can allow for media files to be shared between multiple microservices. In one example, the file storage database 234 can be S3 storage deployed in Amazon Web Services (AWS), but compatible open-source services like MinIO, Garage, etc., can be substituted in other deployments.

For example, the authentication database 236 can store user credentials and/or security tokens for users of the described system. The client browser 240 can receive a user's credentials and/or security tokens, and the authentication service 229 can authenticate the credentials and/or security tokens by comparing them to the stored credentials and/or tokens in the authentication database 236.

In one embodiment, relational database 232 stores structured representations of image and video contents. In various embodiments, by having individual microservices read from and write to a shared, authoritative data source (the database 232), the system can decouple functionality. In one example, this supports maintenance by restricting the functionality impacted by a given change, as well as supporting scaling by allowing in-demand “hot” services independently. In one example, by indexing media content in a normalized data structure, the system can include data consistency protections. The system can furthermore implement Postgres for one or more databases, which can provide flexibility to work with managed services on AWS, or in self-managed environments.

The system can be configured to include any number of databases of various types as appropriate and based on the system's configurations and/or based on the types of digital media received and processed by the system. In various embodiments, the database 232 and/or the file storage database 234 can include sub-databases, such as an embedding vector database, a metadata database, etc. The system can build and maintain libraries of known identities, stored within the system databases, which can be used to reidentify individual identities across a range of object classes (persons, vehicles, ships, etc.) in all analyzed assets.

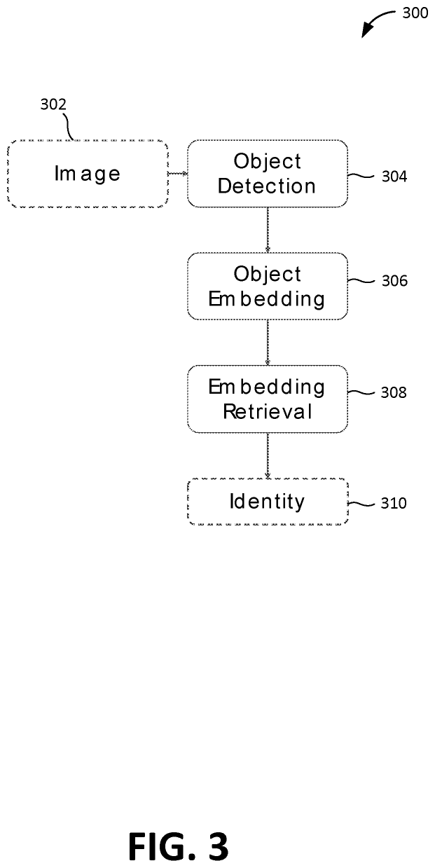

FIG. 3 is a flowchart of an example image identification process 300, in accordance with the disclosed technology. As discussed above in connection with the description of FIG. 1, the system can receive images and furthermore detect objects within the received images. The system can be configured to track objects within (and across) multiple images. In one example, at step 302, the system receives an image. At step 304, the system can perform an object detection step on the received image. In response to detecting an object within the received image (for example, such as a ship, a vehicle, etc.), at step 306, the system can generate an embedding vector corresponding to the detected object. In various embodiments, at step 308, the system can retrieve one or more stored embedding vectors from an embedding vector database for determining whether the vector embedding generated at step 306 matches one or more vector embeddings from an embedding vector database. At step 310, and in response to determining or identifying a match between the embedding vector generated at step 306 and an embedding vector from the database, the system can determine the identity of the object identified within image 302 based on the identity corresponding to the embedding vector from the database.

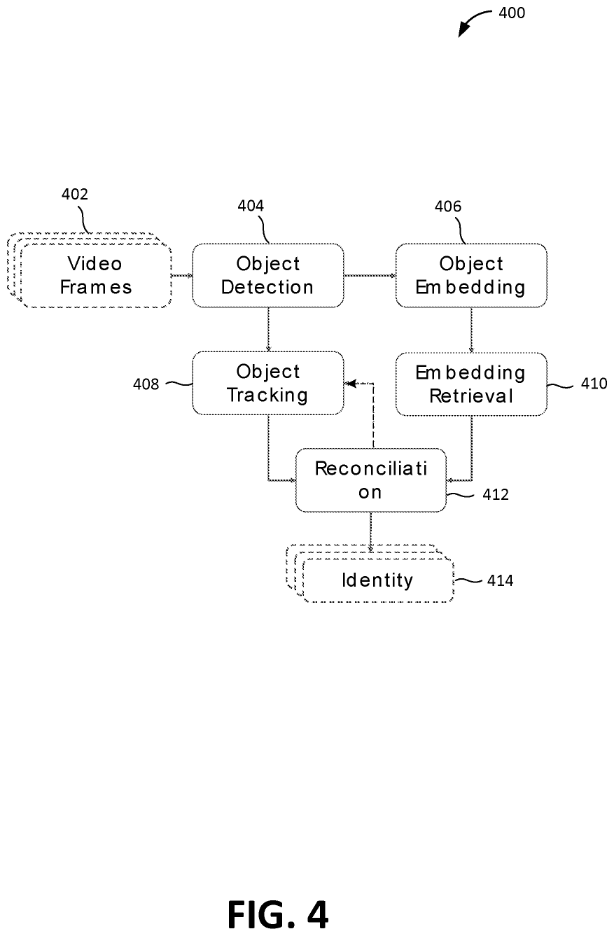

FIG. 4 is a flowchart of an example video identification process 400, in accordance with the disclosed technology. In one or more examples, the system is configured to detect and track objects within a stream of received media/multimedia, such as a video stream or any other data stream from a sensor. For example, the system can detect objects in each frame of the video stream. The system can generate candidate trajectories for the detected objects across multiple adjacent frames (e.g., tracking physical movement of a detected object across space over time based on the data from a sensor). For example, a candidate trajectory can track the physical movement of a detected object across multiple frames or across sensor data over time. The system can generate embeddings representing physical and/or behavioral characteristics of each detected object. In one example, the system can generate a combined score corresponding to an embedding similarity score and a trajectory-based tracking score. For example, the system can compare embeddings and trajectories for different detected objects (e.g., objects detected at the same point or different points in time by the same sensor or different sensor) to generate the combined score. As will be understood, the combined score can indicate the likelihood that the two or more compared objects are the same object shown at different points in time or detected by different sensors. For example, the system can compare one or more embeddings associated with different detected objects. As another example, the system can compare one or more trajectories based on spatiotemporal consistency and/or similarity. Accordingly, the system can determine that an object is correctly reidentified based on a combination of confidence scores corresponding to the object's appearance (as compared between two separately identified objects and their respective embeddings), and the object's trajectory (based on how the object is expected to move between video frames). For example, based on a comparison of the embeddings and candidate trajectories, the system can determine that two or more separately detected objects are actually the same object moving through space and time.

In one example, tracking can allow for the system to regularize identities (of detected objects) within a video based on trajectories corresponding to the identities. In various embodiments, combining visual similarity (object embedding similarities) with location within video (trajectory generation and tracking) results in an overall technical improvement to conventional systems and increases object/identity reidentification accuracy across a plurality of media types. For example, the system can generate a digital signature corresponding to an object's movement or trajectory within a video. For example, a signature can include multiple embeddings, representing different physical and/or behavioral characteristics of the object, concentrated together to form the signature. In some embodiments, the signature can include the trajectory. In one or more examples, the object's digital signature can be mapped to, or otherwise associated with, the object's visual appearance (or an embedding corresponding to the object's visual appearance). Moreover, the system can associate data corresponding to the object's movement/trajectory and data corresponding to the object's visual appearance, to the object's identity within the system. In various embodiments, the system can positively determine that an object is successfully reidentified in a video stream based on a determination that the object's visual appearance and the object's corresponding trajectory/movement are both indicative of a common identity. Combining visual similarity with location within video can reduce false positive identifications, for example, where two similarly appearing objects are misidentified based on appearance alone. In this misidentification example, the system can overcome the false identification issue by further processing the object's movement/trajectory when identifying the object. For example, the system can assume that an object moves continuously through physical space and cannot instantaneously change locations (e.g., the object cannot “teleport” between adjacent frames of a video). Based on this assumption, object detections are associated across time only when their locations are consistent with a continuous path of movement. Detections that imply unrealistic jumps in location are not treated as belonging to the same object.

It should be understood from the discussion herein that the system can include other aspects, in combination with trajectory/movement and visual appearance, in the overall identity reidentification processes. For example, the system can process heat (infrared) profiles, radar profiles, etc., in combination with an object's appearance and/or trajectory, when determining if an object is positively reidentified within a video (or other media).

In one example, the process 400 can begin at step 402, where the system receives a plurality of video frames. At step 404, the system can perform object detection on the plurality of video frames (e.g., perform object detection for each frame in the video). In various embodiments, and in response to performing step 404, the system can proceed to step 406 and/or 408. In one or more embodiments, steps 406 and 408 can be performed in parallel and/or simultaneously. In various embodiments, steps 406 and 408 can be performed in series. In one embodiment, the task queue discussed herein can coordinate the processing of steps 406 and 408. According to various aspects of the present disclosure, steps 406 and 408 correspond to processing a detected object for reidentification and tracking, respectively.

At step 406, the system can generate an object embedding vector corresponding to the object detected within one or more video frames of the plurality of video frames received at step 402. At step 408 the system can perform object tracking. In various embodiments, object tracking includes determining whether an object, as identified from a prior frame, is also identified in a current frame. In various embodiments, the system can implement tracking models, techniques, and algorithms based on Kalman filters, the BYTETracker model, intersection over union (IoU)/Jaccard index, and any other object tracking models. In certain embodiments, the system can implement an object tracker with hyperparameters tuned to one or more object behaviors, without requiring additional model training beyond integration with the embedding model.

In one example, the system can generate tracklets for tracking objects between video frames. Tracklets can be unique to identified objects. Tracklets can correspond to an object's trajectory based on movement between frames. In one embodiment, the system can generate a tracklet for an identified object, where the tracklet includes a sequence of positions corresponding to the detected object (such as bounding box positions), where the sequence can represent a trajectory for the detected object. In various embodiments, the system can generate tracklets via one or more models such as a Yolo model (version v5, or another appropriate version), a region-based convolutional neural network, etc. In one example, by implementing tracklets, the system can track an object's trajectory within a plurality of video frames or images despite potential noise, errors, occlusions, etc., within the frames.

In various embodiments, Yolo models can be configured for prioritizing speed and iteration. In one embodiment, Yolo is a single-stage object detection framework, meaning that both bounding boxes and labels for objects in an image are provided in a single model execution. Compared to two-stage detectors, which separate box proposals and labeling into separate models, Yolo architectures can perform inferences much more quickly, supporting future integration into near real-time frameworks. Complementarily, single-stage architectures are faster to train and tune than two-stage architectures, allowing for faster feedback collection on model performance and dataset quality.

In one embodiment, the system can leverage a TrackEval repository, or the like, for evaluating object tracker performance. Evaluating object tracker performance can include using a (higher order tracking accuracy) HOTA metric and the MOT20 dataset. As will be understood by one of ordinary skill in the art, MOT20 is a multi-object tracking benchmark including crowds of hundreds of people in each image frame. In at least one example, the disclosed system can achieve at least a score of 0.41, consistent with the scores on the MOT17 benchmark.

At step 410, and in response to generating an embedding vector at step 406, the system can retrieve one or more substantially similar embeddings from the embedding database. As discussed throughout the present disclosure, the system can determine whether objects detected in separate images (or other media) are the same (or similar) based on a similarity score corresponding to their respective embedding vectors.

At step 412, the system can perform a reconciliation including an object's embedding vector and the object's trajectory. In one embodiment, the system can generate a combined score (a combined confidence score) corresponding to an embedding similarity score and a trajectory-based tracking score. For example, the system can compare each embedding for two or more detected objects. As another example, the system can compare each trajectory for two or more detected objects. Based on each comparison, the system can generate a similarity score, which can be combined into the confidence score. Accordingly, the system can determine that an object is correctly reidentified based on a combination of confidence scores corresponding to the object's appearance (as compared between two separately identified objects and their respective embeddings), and the object's trajectory (based on how the object is expected to move between video frames). Said another way, the system can determine that the two or more compared objects are actually the same object moving through physical space over time. In various embodiments, the reconciliation step 412 can include determining whether the detected object's embedding vector and the detected object's trajectory are together indicative of the object's appearance and motion. The system can continuously update a relationship between an objects trajectory and an objects appearance. In one example, the relationship between an object's trajectory and an object's appearance can be a statistical relationship that informs a machine learning model of a predicted next location and appearance corresponding to the object. In at least one example, the system constitutes a technical improvement to object reidentification given the system can be configured to track both an object's appearance and trajectory based on a combined score/metric (similarity in only appearance or trajectory may not satisfy a reidentification confidence score threshold). In various embodiments, at step 414, the system can store information corresponding to an object's trajectory, an object's appearance, a relationship between trajectory and appearance, etc., in association with the object's identity within a system database. For example, the system can include assigning an identifier to the object and its associated data (e.g., embeddings, trajectories, scores).

The process 400 can be performed using multi-modal signals generated by a non-camera sensor. For example, the process 400 can be performed using data from any sensor type (e.g., LiDAR, infrared, radar, audio, radio frequency, any sensor type). As an example, any sensor type can be used to perform object detection at step 404, object embedding at step 406, object tracking at step 408, reconciliation at step 412, and/or identification at step 414. Any sensor data (e.g., multi-modal signal) can be used to generate an embedding/vector and track. The generated embeddings/vectors can be compared to determine a similarity score. The generated tracks can be compared to determine a trajectory score. The system can determine a combined score based on the embeddings and tracks generated by a non-camera sensor. In some embodiments, the non-camera sensor data can be used in conjunction with or without camera data during the process 400.

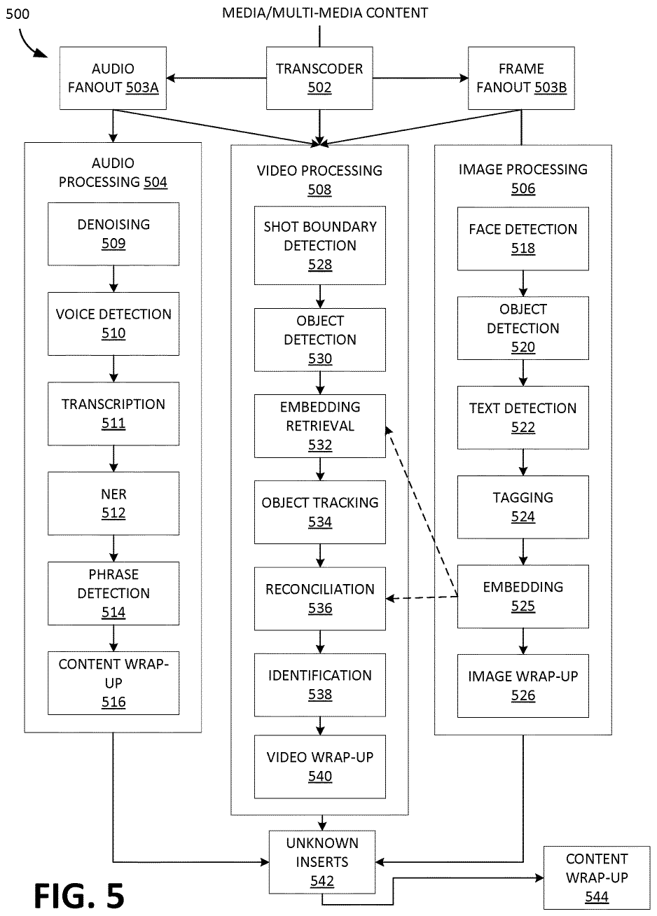

FIG. 5 is a flowchart of an example media processing pipeline or multi-modal signal pipeline 500 (also referred to herein as the “MPP”), in accordance with the disclosed technology. In one example, the MPP 500 can be configured to process media content, multimedia content, etc., such as a video, image, audio, or other types of digital or signal content. In various embodiments, the system can determine (dynamically, and in real time) a particular number (e.g., 1, 2, 3, 5, 10, 15, etc.) of machine learning jobs (such as inference jobs) to run for processing the received digital content. In one example, the system can separate the received digital content into constituent parts (for example, separating an audio component from a video stream). The system can separate the received digital content into constituent parts via a transcoder. In various embodiments, the MPP 500 can include machine learning jobs that are specifically configured for processing the constituent parts. The system can orchestrate the MPP processing, which can include monitoring and processing a status of each job. The system can determine when certain jobs are finished processing, and the system can provide one or more outputs from finished jobs as inputs to other jobs. The system can independently scale each job type (optimizing for speed and/or cost), based on a number of jobs that are anticipated to be processed by a specific machine learning algorithm. The system can reorganize the processed metadata once each of the jobs have been completed to finalize the metadata for each video. The system can store the processed metadata in a database for allowing the metadata to be easily searchable via natural language queries.

In various embodiments, the media processing pipeline 500 can be a directed acyclic graph (DAG). In one example, a DAG is a graph data structure in which nodes can relate to multiple ancestor nodes. In one example, by implementing a DAG, the system can generate inferences across multiple data modalities. For example, inferences from one “branch” of the graph can be used as inputs to ML models on other branches.

In various embodiments, the media processing pipeline 500 can begin in response to a transcoder 502 receiving the media or multi-media content. In one example, the transcoder 502 can be configured to implement one or more digital signal processing (DSP) algorithms for transcoding and creating videos/audio/images that are consistent, for example, with respect to frame rate and size for, efficient processing. The transcoder 502 can be configured to separate the received content into constituent parts. For purposes of example, assume the content received by the transcoder 502 is a video or video stream. Following application of the transcoder 502 to the video stream, the constituent parts (e.g., visual frames, audio) can be passed to audio fanout 503A and frame fanout 503B. For example, audio fanout 503A can include duplicating an audio stream so that the same audio data can be processed concurrently by multiple audio analysis components, such as speech detection, transcription, or acoustic classification. The fanned-out audio data can be passed onto audio processing 504. As another example, the frame fanout 503B can include duplicating individual frames extracted from media data so that the frames can be processed in parallel by different analysis components, such as object detection, classification, or tracking. The fanned-out frames can be passed to image processing 506. Both the fanned-out audio and the fanned-out frames can be passed to video processing 508.

In one embodiment, the system can route constituent audio data to one or more audio processing jobs 504. In one example the one or more audio processing jobs 504 can include audio processing steps such as denoising 509, voice detection 510, transcription 511, named entity recognition (NER) 512, phrase detection 514, and a content wrap up step 516. According to various aspects of the present disclosure, the system can also be configured to perform audio processing steps, processes, and/or algorithms, such as voice activity detection (VAD), punctuation detection, etc. For example, the system can apply denoising to remove any background noise. As another example, during voice detection 510, the system can perform diaratization, which can include identifying multiple speakers. As another example, the transcription 511 can include applying translation and punctuation detection (e.g., such that a transcript can include punctuation rather than a continuous stream of transcribed audio). In one embodiment, the wrap up step 516 includes confirming that the audio metadata processing is finalized, and further ensures that the audio metadata is indexed into the databases and search system. In response to the wrap up step 516, the system can trigger other notifications or other tooling that needs to be triggered based on the information collected in the content. The wrap up step 516 can include indicating an audio metadata processing state. For example, the processing state can be “In Progress,” “success,” or “failure,” depending on one or more conditions in the wrap up worker.

In one embodiment, the system can route constituent image data to one or more image processing jobs 506. In various embodiments the one or more image processing jobs 506 can include face detection 518, object detection 520, text detection 522, image tagging 524, embedding generation 525, and image wrap-up 526. In various embodiments, a face detection processing job 518 can include generating face vector embeddings from identified/detected faces within the image data, comparing face embeddings to embeddings corresponding to known faces and/or famous faces. The face detection processing job 518 can further include comparing a generated face embedding to known faces in a project as well as all unknown faces within the project/job. In various embodiments, if the face is determined to be unknown (it is not close enough in the embedding space using a standard Euclidean distance metric from any face in any of the three datasets (famous, known, and unknown), then the system can include the face embedding into the unknown face dataset. In one embodiment, this processing step includes comparing the face with all other faces identified in that asset (image/video) and then taking a representative face and inserting that embedding into an unknown faces dataset. The next time this person's face appears in a video/image in that project, it will match with this face's embedding and that person's identity can be tracked across videos.

In one embodiment, the one or more image processing jobs 506 can include an object detection 520. For example, object detection 520 can include identifying the presence of objects of interest (e.g., people, vehicles) within image data and determining the spatial regions of the image corresponding to each identified object. For detected objects such as people, the system can perform pose estimation to determine the spatial configuration and relative positions of key points or body parts associated with the detected object. In various embodiments, the text detection 522 can include OCR detection and text recognition. Text detection 522 can also include NER processing for determining whether newly detected text corresponds to known (preidentified) text. The tagging 524 can include tagging the detected objects with descriptive labels or classifications. The system can generate additional embeddings 525 (e.g., in addition to the facial embeddings generated at face detection 518). The system can perform image wrap-up 526 by storing the embeddings, the detected objects (e.g., images), and embeddings for retrieval.

In one embodiment, the system can route constituent video data to one or more video processing jobs 508. In various embodiments, the video processing jobs 508 can include processing steps such as shot boundary detection 526 and a content wrap-up step 528. In particular embodiments, shot boundary detection 526 can include processing the video with a shot lister transcoder for generating a shot list fanout for evaluating individual shots within the video. In one or more examples, shot boundary detection 526 can also include action classification and/or identifying disinformation topics within the video. For example, the system can perform shot boundary detection 526 using the fanned-out audio and fanned-out frames.

The system can perform detection 530 within the video stream to identify objects appearing across multiple frames. The system can then perform embedding retrieval 532 to obtain object representations for detected video objects, including representations generated through the image processing 506. The system can perform object tracking 534 to form candidate tracks representing a detected object movement in the frames over time. For example, the system can associate detected objects (e.g., objects detected in adjacent frames) as the same object to form the candidate tracks. The system can perform reconciliation 536 to resolve relationships between tracked objects and previously identified objects using object representations and track consistency, followed by identification 538 to assign object identities to tracked objects in the video. The system can perform video wrap-up 540, which can aggregate the results of video-level processing, including object tracks, identities, and related metadata, for storage or downstream use.

At step 542, the system can aggregate and compare unknown objects, as detected within the received content. As discussed above in connection with the face detection step 518, the system can store unmatched face embeddings in an “unknown faces” dataset. In various embodiments, the system can be configured to perform a similar operation for unknown embeddings across each of the audio, image, and video processing jobs. In one embodiment, at step 542, the system can match identities, including unknown embeddings, across each of the processed modalities. For example, the system can compare embeddings and trajectories to identify the objects identified by the video processing 508 and the image processing 506.

At step 544, the system can perform a final wrap up process. In one embodiment, the wrap up step 544 can include confirming that the constituent metadata processing is finalized, and further ensures that the processed metadata is indexed into the system databases. The system can trigger other notifications or other tooling that needs to be triggered based on the information collected in the content. The wrap up step 544 can include indicating a metadata processing state (e.g., “In Progress,” “success,” or “failure,” depending on one or more conditions in the wrap up worker). For example, the output

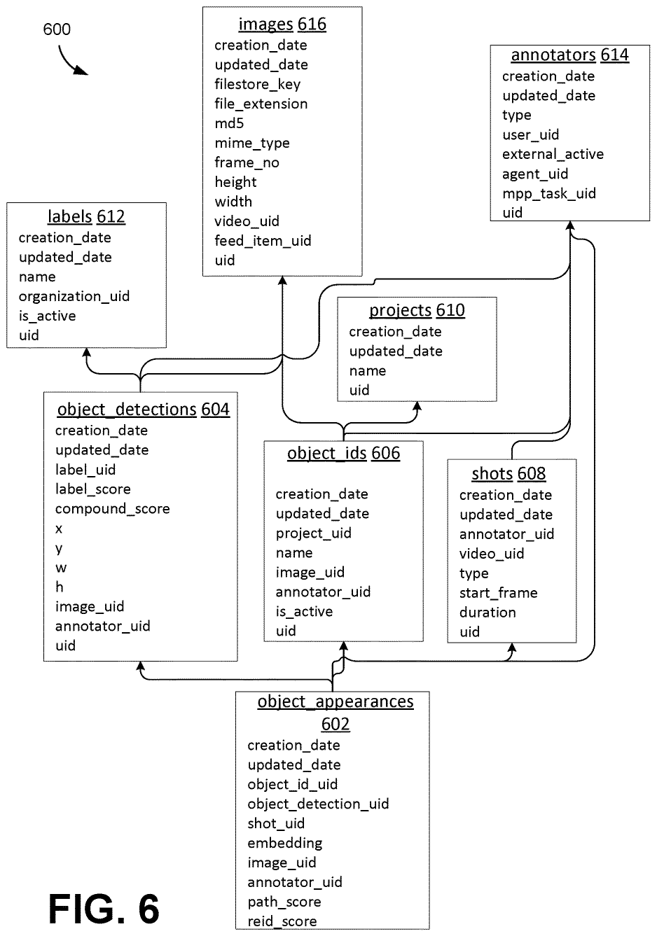

FIG. 6 is an example data structure 600, in accordance with the disclosed technology. In one example, the data structure 600 can be a ReID data model. In various embodiments, the data structure 600 includes a plurality of interlinked data objects. In various embodiments, the data structure 600 includes data objects such as object_appearances 602, object_detections 604, object_ids 606, shots 608, projects 610, labels 612, annotators 614, and images 616. The data structure 600 can include additional objects other than those shown in the present embodiment. In various embodiments, the data objects as shown within the data structure 600 can be populated in response to the system receiving images, videos, audio, etc., and identifying instances of objects (or metadata) within the same.

In one example, the system can include an application programming interface (API) system for retrieving information from the data structure 600. In various embodiments, the API can be a REST API. In a particular embodiment, and with respect to the object_ids 606, the API can include a “Get” command for retrieving all object IDs, a “Patch” command for updating an object's name or active status, and a “Delete” command for deleting an object identification (ID) and associated object appearances of that ID.

In various embodiments, and with respect to the object_appearances 602, the API can include a “Get” command for retrieving an object appearance and related information including associated image, detection, and ID. The API can include a “Patch” command for updating an object ID corresponding to a particular object appearance. In various embodiments, this allows users to manually audit and correct potentially erroneous associations made by the ReID system. In one example, the API can include a command to “Delete” an object appearance.

The data structure 600 can store the ingested videos, images, audio, from the various data sources and data feeds. The data structure 600 can store the metadata corresponding to the objects identified within the ingested videos, images, audio, etc. In response to identifying an object within a newly received video, the system can query the data structure 600 for determining whether the exact object identified in the video was already previously identified within the system. For example, each appearance of an object within a piece of digital content results in the system generating a unique identify corresponding to the object, which can then be queried. In various embodiments, newly detected items are added to the database with each new video/image. In certain embodiments, a newly detected item can be determined to be a reappearance of a previously identified item, which can result in the system generating a link between the items in the data structure 600.

In one embodiment, the data structure 600 can include denormalized ReID data for providing consistency and for integrating ReID with multi-modal machine learning models. The data structure 600 can allow for ReID data to be divided into three distinct tables including object_detections 604, object_ids 606, and object appearances 602. In one embodiment, the object_detections 604 table includes dimensions for bounding boxes and class labels for each observed image. In one embodiment, the object_ids 606 table can enumerate all observed individuals. In a particular embodiment, object_detections 604 and object_ids 606 can be connected by the object_appearances 602 table, which can be configured to associate detections with identities. In one or more embodiments, this data structure can allow for identities to be managed independently of their occurrences in observed imagery.

The shots 608 can represent temporal segments of video defined by shot boundary detection, and each shot is associated with a source video, a start frame, and a duration, allowing object detections and appearances to be localized within specific video segments. The projects 610 can define logical groupings of media assets, machine learning configurations, and derived metadata, enabling objects, detections, and identities to be managed and analyzed within a common project context. The labels 612 can store semantic descriptors or classification outputs produced by machine learning models, such that detected objects and appearances may be tagged with labels indicating object type, category, or other attributes. The annotators 614 can identify the source process or machine learning model responsible for generating a given detection, label, embedding, or identity association, thereby enabling versioning, auditability, and model traceability within the system. The images 616 can represent image assets ingested by the system or extracted from video, and store metadata such as image dimensions, format, frame position, and associations to shots and object detections, allowing detected objects and object appearances to be referenced back to their originating visual content.

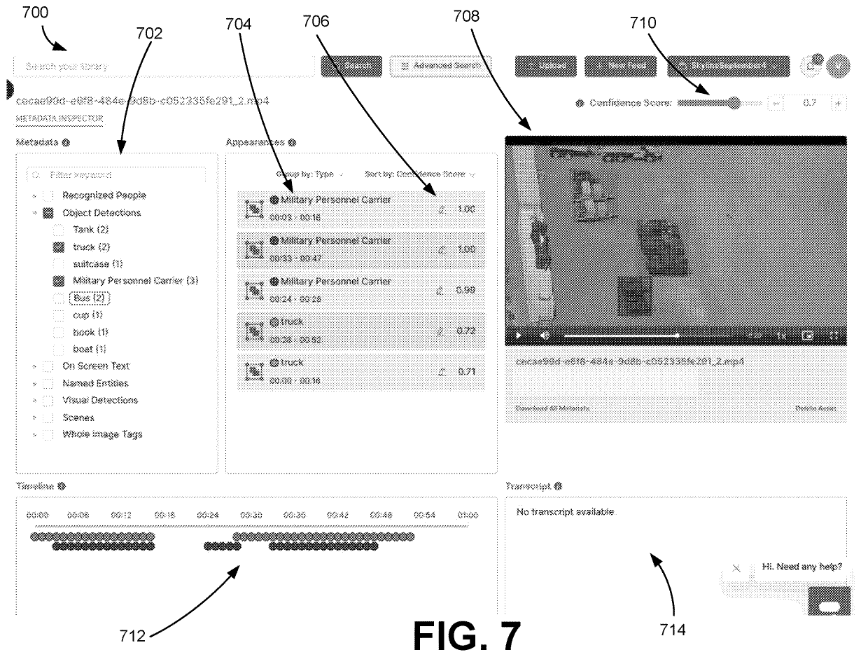

FIG. 7 is a screenshot 700 of an example metadata inspection interface, in accordance with the disclosed technology. In one example, the screenshot 700 of the example metadata inspection interface allows for a user to apply one or more filters, via selecting one or more filter options in a metadata dropdown menu 702, to a plurality of instances of detected metadata. In various embodiments, by selecting one or more filter options in the metadata dropdown menu 702, a system user can search for specific metadata stored within the system. In one embodiment, the detected metadata is stored in a system database, such as the database 232 or the file storage 234. As shown in the present embodiment, the metadata filters “truck” and “military personnel carrier” are both selected. Accordingly, and in response to selecting the “truck” and “military personnel carrier” metadata filters, the system can retrieve metadata stored within a system database and identified as a “truck” or a “military personnel carrier.” The system can display instances of identified “trucks” or “military personnel carriers” from a particular video in the appearances pane 704. In various embodiments, the appearances pane 704 displays instances of the selected metadata filters, as identified within a video. The appearances pane 704 can also include confidence scores 706 corresponding to each displayed metadata appearance/instance. Also shown in the screenshot 700 of the metadata inspection interface is a thumbnail 708. The thumbnail 708 displays the particular media in which the filtered metadata is identified. As shown in the present embodiment, the thumbnail 708 shows one or more military personnel carriers and or trucks. The system can generate boundaries, or boxes, around the identified objects in the thumbnail 708.

In one embodiment, the metadata inspection interface 700 can include a confidence score filter 710. In one example, the confidence score filter 710 can allow for a user to increase or decrease a confidence score threshold. For example, in the present embodiment the confidence score threshold is set to 0.7. Accordingly, the system may only display metadata with a confidence score that meets or exceeds the threshold confidence score of 0.7. In this way, the system allows for a user to control which pieces of metadata are within the interface. In various embodiments, the metadata inspection interface can include a metadata timeline 712. In one example, the metadata timeline 712 can include a visual representation of each instance of an identified object within a particular piece of media (such as the video shown in the thumbnail). In various embodiments, the metadata timeline 712 allows for a user to identify when various targets of interest appear and disappear within a video. In one embodiment, the metadata timeline 712 allows for a user to determine is particular metadata instances/entries have co-occurred in a video.

According to various aspects of the present disclosure, the metadata inspection interface can also include a transcript pane 714. While the transcript pane 714 as shown in the present embodiment does not include a transcript, it should be understood from the discussion herein that the system can generate a transcript for spoken language identified within an audio component of a video. Moreover, the system can match objects/identities/metadata as identified within spoken language to objects/identities/metadata identified within images and pictures. For example, if the video shown in the thumbnail 708 included an audio component in which the spoken language “truck” was detected, the system could identify, or tag, the instance of “truck” within the spoken language and link tagged instance to the instances identified within the video.

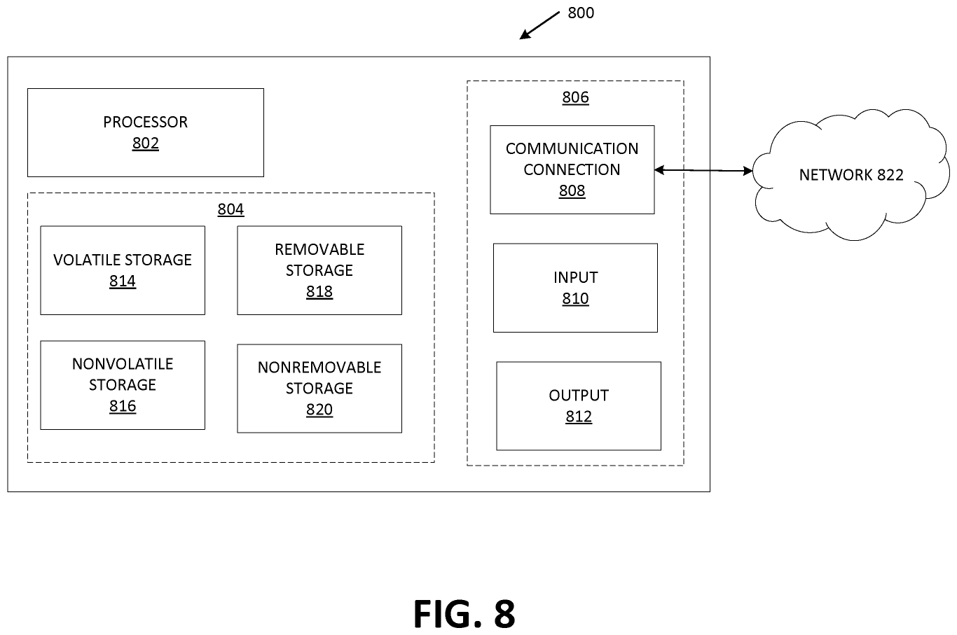

FIG. 8 depicts an example of a diagrammatic representation of a computer device 800 within which a set of instructions, when executed, may cause the computing device 800 to perform any one or more of the methods described above. One or more instances of the computing device 800 can operate, for example, the server on which the system architecture 200 resides and/or a computing device configured to access the system architecture. For example, the computing device 800 can perform any of the functionality described herein, including but not limited to the functionality described in FIG. 1-7. In some examples, the machine may be connected using network 822 to other machines. In a networked deployment, the computing device 800 may operate in the capacity of a server or a client user machine in a server-client user network environment, or as a peer machine in a peer-to-peer (or distributed) network environment.

Computing device 800 may comprise hardware or a combination of hardware and software. The functionality to facilitate identification and reidentification may reside in one or a combination of computing devices 800. Computing device 800 depicted in FIG. 8 may represent or perform functionality of an appropriate computing device 300, or a combination of computing devices 800, such as, for example, a component or various components of the described identification and reidentification system, a computing device, a processor, a server, a gateway, a database, a firewall, a router, a switch, a modem, an encryption tool, a virtual private network (VPN), or the like, or any appropriate combination thereof. It is emphasized that the block diagram depicted in FIG. 8 is an example and is not intended to imply a limitation to a specific example or configuration. Thus, computing device 800 may be implemented in a single device or multiple devices (e.g., single server or multiple servers, single gateway or multiple gateways, single controller, or multiple controllers). Multiple network entities may be distributed or centrally located. Multiple network entities may communicate wirelessly, via hard wire, or any appropriate combination thereof.

Embodiments of the computing device 800 may comprise a processor 802 and a memory 804 coupled to processor 802. The memory 804 may contain executable instructions that, when executed by the processor 802, may cause the processor 802 to effectuate operations associated with identification and reidentification. As evident from the description herein, the computing device 800 is not to be construed as software per se.

In addition to a processor 802 and memory 804, a computing device 800 may include an input/output system 806. The processor 802, memory 804, and input/output system 806 may be coupled together to allow communications between them. Each portion of the computing device 800 may comprise circuitry for performing functions associated with each respective portion. Thus, each portion may comprise hardware, or a combination of hardware and software. An input/output system 806 may be capable of receiving or providing information from or to a communications device or other network entities configured for identification and reidentification. For example, the input/output system 806 may include a wireless communication (e.g., 8G/4G/5G/GPS) card. The input/output system 806 may be capable of receiving or sending video information, audio information, control information, image information, data, or any combination thereof. Input/output system 806 may be capable of transferring information with the computing device 800. In various configurations, the input/output system 806 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, the input/output system 806 may comprise a Wi-Fi finder, a two-way GPS chipset or equivalent, or the like, or a combination thereof.

Embodiments of the input/output system 806 of a computing device 800 also may contain a communication connection 808 that allows the computing device 800 to communicate with other devices, network entities, or the like. The communication connection 808 may comprise communication media. Communication media may typically embody computer-readable instructions, data structures, program modules or other data in a modulated data signal such as a carrier wave or other transport mechanism and may include any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. The input/output system 806 also may include an input device 810 such as keyboard, mouse, pen, voice input device, or touch input device. The input/output system 806 may also include an output device 812, such as a display, speakers, or a printer.

The memory 804 may store any information utilized in conjunction with identification and reidentification. Depending upon the exact configuration or type of processor, a memory 804 may include a volatile storage 814 (such as some types of RAM), a nonvolatile storage 816 (such as ROM, flash memory), or a combination thereof. The memory 804 may include additional storage (e.g., a removable storage 818 or a non-removable storage 820) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by a computing device 800. The memory 804 may comprise executable instructions that, when executed by a processor 802, cause the processor 802 to effectuate operations associated with identification and reidentification as described with reference to FIGS. 1-7.

### Conclusion

The disclosure herein can be carried out wholly or in part by a computing environment, which can include a server computer, or any other system providing computing capability. Alternatively, the computing environment may employ a plurality of computing devices that may be arranged, for example, in one or more server banks or computer banks or other arrangements. Such computing devices can be located in a single installation or may be distributed among many different geographical locations. For example, the computing environment can include a plurality of computing devices that together may include a hosted computing resource, a grid computing resource, and/or any other distributed computing arrangement. In some cases, the computing environment can correspond to an elastic computing resource where the allotted capacity of processing, network, storage, or other computing-related resources may vary over time.

Various applications and/or other functionality may be executed in the computing environment according to various embodiments. Also, various data is stored in a database that is accessible to the computing environment. The database can be representative of a plurality of databases as can be appreciated. The data stored in the database, for example, may be associated with the operation of the various applications and/or functional entities described herein.

The computing environment can communicate with a plurality of computing devices and querying devices (which may include computing devices) via a network. The network includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

Aspects, features, and benefits of the systems, methods, processes, formulations, apparatuses, and products discussed herein will become apparent from the information disclosed in the figures and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the figures or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the systems and processes to the precise forms disclosed. Many modifications and variations are possible in light of the above teaching.

The embodiments were chosen and described in order to explain the principles of the systems and processes and their practical application so as to enable others skilled in the art to utilize the systems and processes and various embodiments and with various modifications as are suited to the particular use contemplated. Alternative embodiments will become apparent to those skilled in the art to which the present systems and processes pertain without departing from their spirit and scope. Accordingly, the scope of the present systems and processes is defined by the appended claims rather than the foregoing description and the exemplary embodiments described therein.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed systems and processes may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed systems and processes are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that affects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems and processes are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the systems and processes is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems and processes will be readily discernible from the description herein, by those of ordinary skill in the art. Many embodiments and adaptations of the disclosure and claimed systems and processes other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems and processes. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems and processes. In addition, some steps may be carried out simultaneously, contemporaneously, or in synchronization with other steps.

The embodiments were chosen and described in order to explain the principles of the claimed systems and processes and their practical application so as to enable others skilled in the art to utilize the systems and processes and various embodiments and with various modifications as are suited to the particular use contemplated. Alternative embodiments will become apparent to those skilled in the art to which the claimed systems and processes pertain without departing from their spirit and scope. Accordingly, the scope of the claimed systems and processes is defined by the appended claims rather than the foregoing description and the exemplary embodiments described therein.

These and other aspects, features, and benefits of the claims will become apparent from the detailed written description of the aforementioned aspects taken in conjunction with the accompanying drawings, although variations and modifications thereto may be effected without departing from the spirit and scope of the novel concepts of the disclosure.

What is claimed is:

1. A system, comprising:
a memory storing executable instructions; and
a processor in communication with the memory configured to execute the instructions to:
receive media data comprising a sequence of frames captured by at least one sensor;
identify one or more object detections within the sequence of frames;
generate a track for each of the one or more object detections;
generate at least one vector representation for each of the one or more object detections, wherein the at least one vector representation represents a physical or behavioral characteristic of a respective object detection;
retrieve a plurality of prior tracks and a plurality of prior vector representations from the memory, wherein the plurality of prior tracks and the plurality of prior vector representations are associated with a plurality of prior object detections;
compare a particular track associated with a particular object detection of the one or more object detections to each of the plurality of prior tracks to determine a trajectory score with respect to each of the plurality of prior tracks;
compare at least one particular vector representation associated with the particular object detection to each of the plurality of prior vector representations to determine a similarity score with respect to each of the plurality of prior vector representations; and
upon a determination that a particular trajectory score corresponding to a particular prior track and a particular similarity score corresponding to a particular prior vector representation exceed at least one predefined threshold, determine that the particular object detection identifies a same object associated with the particular prior track and the particular prior vector representation.

2. The system of claim 1, further configured to:
assign an object identity to the particular object detection and a particular prior object detection corresponding to the particular prior track and the particular prior vector representation.

3. The system of claim 2, wherein the object identity corresponds to the same object.

4. The system of claim 1, wherein the particular track and the particular prior track represent a movement path of the same object over a period of time.

5. The system of claim 1, wherein the plurality of prior tracks and the plurality of prior vector representations are generated from the media data from the sequence of frames.

6. The system of claim 1, wherein plurality of prior tracks and the plurality of prior vector representations are generated from prior media data from a prior sequence of frames.

7. A method, comprising:
receiving, via one of one or more computing devices, media data comprising a sequence of frames captured by at least one sensor;
identifying, via one of the one or more computing devices, one or more object detections within the sequence of frames;
generating, via one of the one or more computing devices, a track for each of the one or more object detections;
generating, via one of the one or more computing devices, at least one vector representation for each of the one or more object detections, wherein the at least one vector representation represents a physical or behavioral characteristic of a respective object detection;
retrieving, via one of the one or more computing devices, a plurality of prior tracks and a plurality of prior vector representations from a data store, wherein the plurality of prior tracks and the plurality of prior vector representations are associated with a plurality of prior object detections;
comparing, via one of the one or more computing devices, a particular track associated with a particular object detection of the one or more object detections to each of the plurality of prior tracks to determine a trajectory score with respect to each of the plurality of prior tracks;
comparing, via one of the one or more computing devices, at least one particular vector representation associated with the particular object detection to each of the plurality of prior vector representations to determine a similarity score with respect to each of the plurality of prior vector representations; and
upon a determination that a particular trajectory score corresponding to a particular prior track and a particular similarity score corresponding to a particular prior vector representation exceed at least one predefined threshold, determining, via one of the one or more computing devices, that the particular object detection identifies a same object associated with the particular prior track and the particular prior vector representation.

8. The method of claim 7, further comprising:
combining the particular trajectory score and the particular similarity score to generate a combined score; and
determining that the combined score exceeds the at least one predefined threshold.

9. The method of claim 7, wherein determining that the particular trajectory score corresponding to the particular prior track and the particular similarity score corresponding to the particular prior vector representation exceed the at least one predefined threshold comprises:
determining that the particular trajectory score exceeds a trajectory threshold; and
determining that the particular similarity score exceeds a similarity threshold, wherein the at least one predefined threshold comprises the trajectory threshold and the similarity threshold.

10. The method of claim 7, wherein each of the one or more object detections comprises a person, vehicle, or vessel.

11. The method of claim 7, wherein identifying the one or more object detections comprises performing object detection on each frame in the sequence of frames.

12. The method of claim 7, wherein generating the track for each of the one or more object detections comprises associating the one or more object detections in adjacent frames of the sequence of frames.

13. A non-transitory computer-readable medium embodying a program that, when executed by at least one computing device, cause the at least one computing device to:
receive sensor data captured by at least one sensor over a period of time;
identify one or more object detections within the sensor data;
generate a track for each of the one or more object detections;
generate at least one vector representation for each of the one or more object detections, wherein the at least one vector representation represents a physical or behavioral characteristic of a respective object detection;
retrieve a plurality of prior tracks and a plurality of prior vector representations from a data store, wherein the plurality of prior tracks and the plurality of prior vector representations are associated with a plurality of prior object detections;
compare a particular track associated with a particular object detection of the one or more object detections to each of the plurality of prior tracks to determine a trajectory score with respect to each of the plurality of prior tracks;
compare at least one particular vector representation associated with the particular object detection to each of the plurality of prior vector representations to determine a similarity score with respect to each of the plurality of prior vector representations; and
upon a determination that a particular trajectory score corresponding to a particular prior track and a particular similarity score corresponding to a particular prior vector representation exceed at least one predefined threshold, determine that the particular object detection identifies a same object associated with the particular prior track and the particular prior vector representation.

14. The non-transitory computer-readable medium of claim 13, wherein the at least one sensor comprises at least one of: a photographic camera, a video camera, a radar sensor, a LiDAR sensor, a microphone, an infrared sensor, or a synthetic aperture radar sensor.

15. The non-transitory computer-readable medium of claim 13, the at least one particular vector representation and the particular prior vector representation correspond to a single characteristic of the same object.

16. The non-transitory computer-readable medium of claim 13, wherein the particular trajectory score measures a spatiotemporal consistency between the particular prior track and the particular track.

17. The non-transitory computer-readable medium of claim 13, wherein comparing the at least one particular vector representation with the particular prior vector representation comprises calculating a distance metric between the at least one particular vector representation and the particular prior vector representation.

18. The non-transitory computer-readable medium of claim 13, further configured to cause the at least one computing device to:
generate each of the plurality of prior tracks for each of the plurality of prior object detections based on the sensor data.

19. The non-transitory computer-readable medium of claim 13, further configured to cause the at least one computing device to:
generate each of plurality of prior vector representations for each of the plurality of prior object detections based on the sensor data.

20. The non-transitory computer-readable medium of claim 13, further configured to cause the at least one computing device to:
store, in the data store, the plurality of prior tracks and the plurality of prior vector representation.
